(19) United States
(12) Patent Application Publication
(10) Pub. No.: US 2022/0309758 A1
(43) Pub. Date: Sep. 29, 2022

(54) 3D Effect Inside Case

(71) Applicant: Yu Zhang, Monterey Park, CA (US)

(72) Inventor: Yu Zhang, Monterey Park, CA (US)

(21) Appl. No.: 17/215,418

(22) Filed: Mar. 29, 2021

(51) Int. Cl. G06T 19/20; G06T 13/20; G06F 3/14

(52) U.S. Cl. CPC G06T 19/20; G06T 13/20; G06F 3/14; G06T 2219/2016; G06T 2200/04; G06F 3/012

(57) ABSTRACT

A transparent display device that can be mounted to existing computer cases with a window. Once the device is connected, software guides users to align the inside edges of their case to create a 3D effect inside the case. The software allows users to add their custom components so that the 3D effects can interact with those components. An example would be animated waves will appear to splash against a graphics card instead of moving through it. The software will also have a store allowing users to find and download additional animation, 3D effects, music visualizers, and customize their machine by combining all these elements.

### CROSS REFERENCE TO RELATED APPLICATIONS

This application claims the benefit of U.S. Provisional Application No. 63/049,261, filed Jul. 8, 2020, which is incorporated by reference herein in its entirety.

### TECHNICAL FIELD

Embodiments described herein relate generally to electrical device, and more particularly to systems, methods, and devices for using transparent display in combination with software to create 3D effect inside computer case.

### BACKGROUND

One major appeal of building your own personal computer, hereby shortened as PC, is the high level of customization, not just for the internal components, but also the look of your machine. Components are available in a wide range of colors, with added options such as colorful LEDs, and even LCD screens that can display important system information as well as video and GIFs. There are PC cases with a transparent screen that can display a moving image while allowing you to see inside to the components. This technique has been popular among the DIY crowd for many years prior, with several instructional videos online.

PC enthusiasts are constantly innovating and inventing new ways to customize their machines, but the following factors have limited their creativity. Different manufacturers have proprietary software that makes syncing color and lighting patterns impossible if not purchased from the same manufacturer. Certain elements such as LCD screens are considered premium and can be prohibitively expensive. Most personal computers require empty space for air to circulate and cool the components. Users are not able to add physical parts that might impede the air flow so instead many choose to place a small toy or figurine to fill the space and add a personal flair.

Therefore, a need exists in the field for a novel system to visually unify components from different manufacturers. There is also a need for the system to utilize software to add customization elements in lieu of expensive hardware. Finally, there is a need for the system to create stunning 3D animations to fill the empty space inside the PC case.

### BRIEF SUMMARY OF THE INVENTION

The present invention comprises a novel device with a transparent screen that a user can mount to their existing PC case with a glass or plastic window. Once the device is plugged into the PC, a companion application will run that allows the user to set the 3D effect in real time depending on where the user is viewing the PC. The application will allow users to recreate their components such as motherboard, graphic cards, fans, etc in the software so that all animation and visualizers will account for the physical components inside the case and interact accordingly. The user will be able to browse an online store of different 2D and 3D images, videos, animations, static and interactive music visualizers. They can download and immediately see the effect on their device.

### BRIEF DESCRIPTION OF THE DRAWINGS

Some embodiments of the present invention are illustrated as an example and are not limited by the figures of the accompanying drawings, in which like references may indicate similar elements and in which:

FIG. 1 depicts an exploded perspective view of one example of how the device can be installed on a PC with a removable glass window according to various embodiments of the present invention.

FIG. 2 illustrates the front and back of the device according to various embodiments described herein.

FIG. 3 shows how the software will assist users in defining the dimensions and viewing angle of their device according to various embodiments described herein.

FIG. 4 shows how the software allows users to recreate their components virtually so animations and effects will be able to interact with them according to various embodiments described herein.

FIG. 5 shows a user selecting a theme and seeing it applied in real-time on the device according to various embodiments described herein.

FIG. 6 shows a real life example of FIG. 5.

FIG. 7 illustrates an example method to create the 3D effect.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specific present disclosure and will not be interpreted in an idealized or overly formal sense unless expressly so defined herein.

In describing the invention, it will be understood that a number of techniques and steps are disclosed. Each of these has individual benefits and each can also be used in conjunction with one or more, or in some cases aons, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

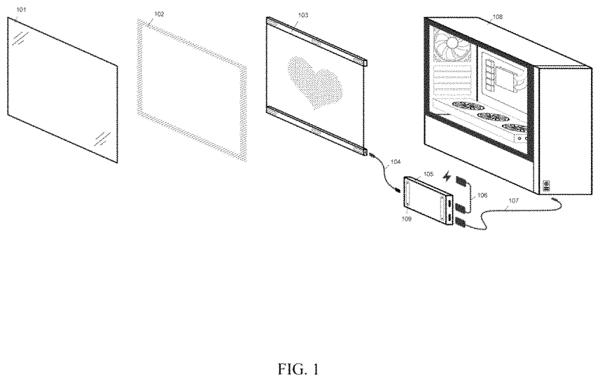

The present invention will now be described by referencing the appended figures representing preferred embodiments. FIG. 1 depicts an exploded perspective view of one example of how the device can be installed on a PC with a removable glass window according to various embodiments of the present invention. In this example, the PC case 108 has a removable glass window 101. This type of case is extremely popular and very common, but can vary greatly in size and the size of the glass window. The device 103 will come with a thin sticker sheet 102 that is two sided. On the side facing the glass 101, it will be a black adhesive. On the side facing the device 103, it will be a reflective material with metal elements on the top and bottom that allows for the device to attach via magnets or adhesive. The sticker 102 will come to fit the largest of these cases and their glass window 101. There is an exact cut out in the middle for the user to install the device 103. The sticker 102 is made of a thin material and can be cut to size by the user at home with scissors.

The device 103 then attaches to the sticker 102 using adhesive or magnets. The device 103 is then connected to the controller box 105 by a cable 104. The control box 105 will transfer images and video to the display as well as power the LEDs 206. The control box 105 is the size of a standard SSD drive and includes the standard mounting screw holes 109 so that the control box 105 can be mounted anywhere a SSD drive can be mounted. In the case that the control box 105 cannot draw enough current from the usb cable 107, a power cable 106 can be included that has many connector options including DC, molex, and sata.

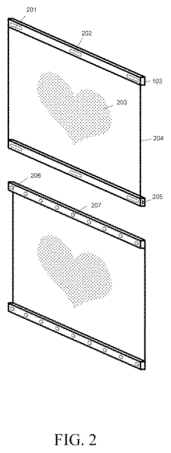

FIG. 2 offers a zoomed view of the front and back of the device 103. Adhesive or magnetic pads 201 are placed on the top and bottom frame to secure the device to the sticker 102. For future iterations, a camera 202 can be used to track the user's face or eyes so that the 3D effect can adapt as the user is changing their viewing angle. The camera can also track a small marker that can be attached to cameras or smartphones. The display 203 is a transparent or semi-transparent display. The device 103 has a thin frame 204 made of metal or plastic that will protect the display 203. The device 103 has a connector 205 that allows the device 103 to be connected to the control box 105.

On the other side of the device 103, there is a row or multiple rows of white or color LEDs 206. Most transparent or semi-transparent displays 203 require a very bright back light in order to display the image clearly. The LEDs 206 are designed to light up the inside of the user's PC 108 to enhance the 3D effect. For future iterations, a depth-sensing or 3D camera 207 can be used to scan and automatically recreate the user's PC virtually.

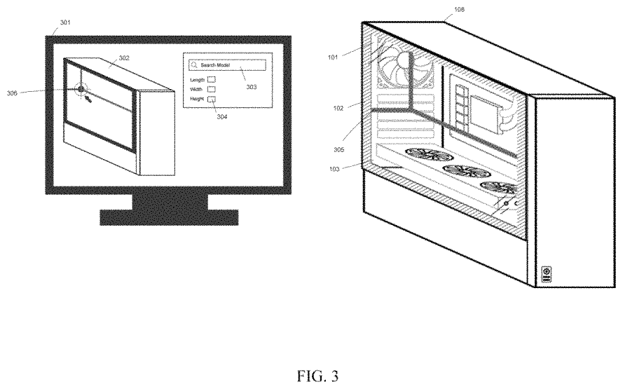

FIG. 3 shows how the software will assist users in defining the dimensions and viewing angle of their device according to various embodiments described herein. In this example, a monitor 301 is illustrated, but a similar software experience can be had on the user's smartphone or tablet. The software or application will display a virtual PC 302 recreating the user's PC 108. Users can search a database for their case model 303, select from a list of different types of cases, or manually enter the dimensions 304 of their case. In order for the 3D effect to be effective, the user will need to match the inside edges of their virtual PC 302 with the inside edges of their PC 108. The user can drag the virtual corner 306 in the software or application and see the exact guide 305 on the device 103 in real time allowing them to match the two from their viewing angle.

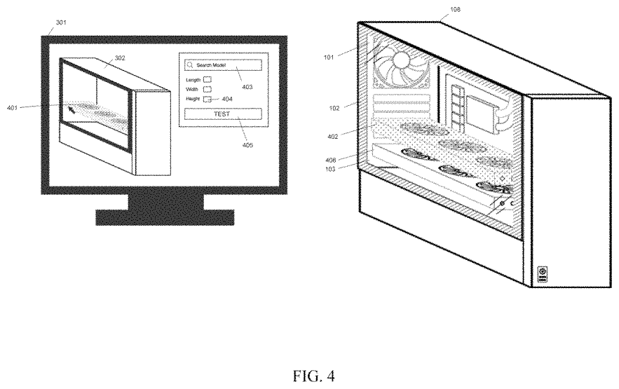

FIG. 4 shows how the software allows users to recreate their components virtually so animations and effects will be able to interact with them according to various embodiments described herein. The software or application will display a virtual PC 302 recreating the user's PC 108. Users can search a database for their component model 403, select from a list of different types of components, or manually enter the dimensions 404 of their components. The user can change the position and size of their virtual component 401 in their virtual pc 302 and see the change in real time on the device 103. The user has to match the size and position of the virtual component displayed on the device 402 with their physical component 406. The test button 405 will display a series of test animations on the device 103 with the virtual component displayed on the device 402 removed so the users can see if the animations are interacting correctly with their physical component 406.

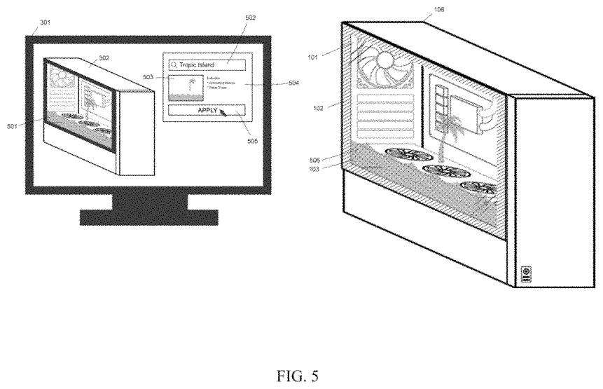

FIG. 5 shows a user selecting a theme and seeing it applied in real-time on the device 103 according to various embodiments described herein. The software or application will display a virtual PC 302 recreating the user's PC 108. Users can search a database or online store 502 for different images, videos, interactive wallpaper, 3D models, 3D animation, sound visualizer, music visualizer to display on the device 103. The user can see a visual preview 503 before applying their choice by clicking the apply button 505. Each option will also include a short description 504. Some options can be broken down into separate elements. There are countless variations of PC builds. The software or application will allow users to fully customize the 3D effect by allowing them to mix and match different elements from different themes or packs, and to upload their own 3D model and resize and position them. In the example illustrated in FIG. 5, the device 103 will display the 3D effect 506 as two separate elements, the animated waves in the forefront and the stationary palm tree in the background. Since the user recreated their physical component in the virtual PC 302, the animated waves will appear to splash off the sides of the component. Similarly, the palm tree will appear as if it is growing out of the component.

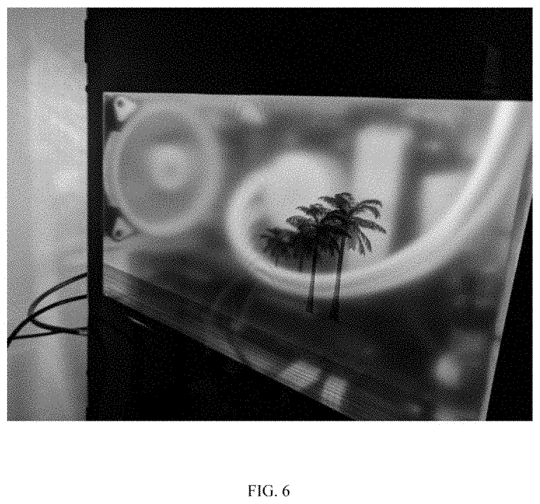

FIG. 6 shows a real life example user selecting a theme and seeing it applied in real time on the device. In this case, the palm tree appears as if it is growing out of the component and appears both in front and behind the white tubing.

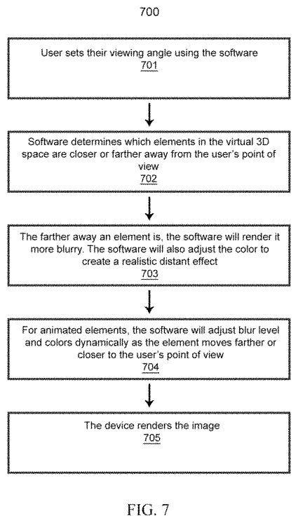

FIG. 7 illustrates an example method 700 to create the 3D effect. Block 701 user sets their viewing angle using the software. For example, by creating their virtual PC 302 in the software. Block 702 software determines which elements in the virtual 3D space are closer or farther away from the user's point of view. Block 703 the farther away an element is, the software will render it more blurry. The software will also adjust the color to create a realistic distant effect. For example, if there were multiple palm trees in the 3D effect 506, then the trees closer to the back of the case will appear more blurry and darker. Block 704 for animated elements, the software will adjust blur level and colors dynamically as the element moves farther or closer to the user's point of view. For example, if there was an animated turtle in the 3D effect 506, then as the turtle crawls from the front of the case to the back, it would appear to get more blurry and change color to give the illusion it is moving farther away. Block 705 the device renders the image.

It will be appreciated that, although specific embodiments of the present disclosure are described herein for purposes of illustration, various modifications may be made without departing from the spirit and scope of the present disclosure. Accordingly, the present disclosure is not limited except as by the appended claims. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure. The various embodiments described above can be combined to provide further embodiments. All of the U.S. patents, U.S. patent application publications, U.S. patent applications, foreign patents, foreign patent applications and non-patent publications referred to in this specification and/ or listed in the Application Data Sheet are incorporated herein by reference, in their entireties. Aspects of the embodiments can be modified, if necessary to employ concepts of the various patents, applications and publications to provide yet further embodiments.

What is claimed is:

1. A transparent display device, comprising:
a transparent or semi-transparent screen that shows a color white as transparent thereby allowing a user to see through to inside of a computer;
a camera located in front of the transparent display device to track the user's face or eyes; and
a 3D camera in back of the transparent display device to automatically scan and recreate the user's computer,
wherein the front of the transparent display device has adhesive to attach it to the computer, and
wherein the back of the transparent display device has a row of bright white LEDs on top and bottom frame of the computer.

2. The transparent display device of claim 1, wherein the transparent display device is connected to a control box via a cable and the control box is connected to the computer through an internal USB cable.

3. The transparent display device of claim 2, wherein the control box is same to a size of current internal SSD drives, and wherein the control box includes adhesives to attach the control box to the case.

4. The transparent display device of claim 2, wherein the control box is wirelessly connected to the user's computer, smartphone, smartwatch, or tablet.

5. The transparent display device of claim 1, wherein the transparent display device is connected to a control box via a cable and the control box is connected to the computer through an external USB cable.

6. The transparent display device of claim 1, wherein the transparent display device has same mounting holes and system so that it can be mounted anywhere inside the case that allows for SSD.

7. The transparent display device of claim 1, further including a two sided sticker that attaches to the glass of the computer case and allows for the transparent display device to be attached via the adhesive, wherein on the side attached to the glass, the two sided sticker is black with an exact window cut out to allow for the transparent display device.

8. The transparent display device of claim 5, wherein on an opposite side, the two sided sticker is a mirror, wherein strips of metal are located above and below the cutout to allow the transparent display device to be attached thereon, and wherein the two sided sticker is thin to allow user to trim the two sided sticker using household scissors.

9. A transparent display device, comprising:
a transparent or semi-transparent screen that shows a color white as transparent thereby allowing a user to see through to inside of a computer;
a camera located in front of the transparent display device to track the user's face or eyes; and
a 3D camera in back of the transparent display device to automatically scan and recreate the user's computer,
wherein the front of the transparent display device has magnets to attach it to the computer, and
wherein the back of the transparent display device has a row of bright color LEDs on top and bottom frame of the computer.

10. The transparent display device of claim 9, wherein the transparent display device is connected to a control box via a cable and the control box is connected to the computer through an internal USB cable.

11. The transparent display device of claim 10, wherein the control box is same to a seize of current internal SSD drives, and wherein the control box includes magnets to attach the control box to the case.

12. The transparent display device of claim 10, wherein the control box is wirelessly connected to the user's computer, smartphone, smartwatch, or tablet.

13. The transparent display device of claim 9, wherein the transparent display device is connected to a control box via a cable and the control box is connected to the computer through an external USB cable.

14. The transparent display device of claim 9, wherein the transparent display device has same mounting holes and system so that it can be mounted anywhere inside the case that allows for SSD.

15. The transparent display device of claim 9, further including a two sided sticker that attaches to the glass of the computer case and allows for the transparent display device to be attached via the magnets, wherein on the side attached to the glass, the two sided sticker is black with an exact window cut out to allow for the transparent display device.

16. The transparent display device of claim 13, wherein on an opposite side, the two sided sticker is a highly reflective surface, wherein strips of metal are located above and below the cutout to allow the transparent display device to be attached thereon, and wherein the two sided sticker is thin to allow user to trim the two sided sticker using household scissors.

17. A method of utilizing software and a transparent display device to create an illusion of 3D space inside a user's computer case based on the viewing angle of the user in real time, the transparent display device comprising:
a transparent or semi-transparent screen that shows a color white as transparent thereby allowing a user to see through to inside of a computer;
a camera located in front of the transparent display device to track the user's face or eyes; and
a 3D camera in back of the transparent display device to automatically scan and recreate the user's computer,
wherein the front of the transparent display device has adhesive to attach it to the computer, and
wherein the back of the transparent display device has a row of bright white LEDs on top and bottom frame of the computer.

18. The method of claim 17, wherein the software is configured to allow use to recreate the size and dimensions of their components virtually so that animations and effects appear to interact with those objects when viewed through the transparent display device.

19. The method of claim 17, wherein the illusion of 3D space inside the user's computer case based on a viewing angle of the camera in a real time.

20. The method of claim 19, wherein the software is configured to allow user to recreate the size and dimensions of their components virtually so that animations and effects appear to interact with those objects when viewed through the transparent display device
